(19) United States
(12) Patent Application Publication
(10) Pub. No.: US 2026/0366353 A1
(43) Pub. Date: Nov. 19, 2026

(54) VEHICLE DOOR APPARATUS

(71) Applicant: AISIN CORPORATION, Kariya (JP)

(72) Inventors: Yusuke KAJINO, Kariya-shi (JP); Yosuke KAJI, Kariya-shi (JP)

(73) Assignee: AISIN CORPORATION, Kariya (JP)

(21) Appl. No.: 19/652,274

(22) Filed: Apr. 20, 2026

(30) Foreign Application Priority Data
May 14, 2025 (JP) 2025-081305

(51) Int. Cl. E05F 15/63

(52) U.S. Cl. CPC E05F 15/63; E05Y 2201/21; E05Y 2201/654; E05Y 2201/668; E05Y 2201/71; E05Y 2900/531

(57) ABSTRACT

A vehicle door apparatus for a vehicle including a vehicle body having a door opening and a door includes: a first link arm, a second link arm, and a door braking unit. The door braking unit includes a rotating body that rotates in response to rotation of the first link arm, and a braking lever that applies braking torque to the first link arm via the rotating body when engaging with the rotating body. The rotating body transitions from one of an engaged state of engaging with the braking lever and a retracted state of not engaging with the braking lever to another of the engaged state and the retracted state in response to rotation of the rotating body. The rotating body transitions to the engaged state when the door is disposed at a fully open position where the door fully opens the door opening.

### CROSS REFERENCE TO RELATED APPLICATIONS

This application is based on and claims priority under 35 U.S.C. § 119 to Japanese Patent Application 2025-081305, filed on May 14, 2025, the entire content of which is incorporated herein by reference.

### TECHNICAL FIELD

This disclosure generally relates to a vehicle door apparatus.

### BACKGROUND DISCUSSION

JP2022-102132A (Reference 1) describes a vehicle including a vehicle body having a door opening, a door configured to open and close the door opening, and a door apparatus connecting the vehicle body and the door. The door apparatus includes a first link arm to be rotatably connected to both the vehicle body and the door, a second link arm to be rotatably connected to both the vehicle body and the door, a lever to be provided at the door opening, and a check mechanism to be provided at the first link arm. In the door apparatus, the first link arm and the second link arm constitute a four-bar linkage mechanism together with the vehicle body and the door. The check mechanism engages with the lever when the door is disposed at a fully open position where the door fully opens the door opening. Thus, the check mechanism holds the door at the fully open position.

In the door apparatus as described above, the check mechanism is provided at a central portion of the link arm in a longitudinal direction. Meanwhile, the lever is provided at the door opening. That is, in the door apparatus, components of a mechanism for holding the door at the fully open position are arranged separately on the vehicle body and the link arm.

A need thus exists for a vehicle door apparatus, which is not susceptible to the drawback mentioned above.

### SUMMARY

A vehicle door apparatus to solve the above-described problem is applied to a vehicle including a vehicle body having a door opening and a door configured to open and close the door opening, and the vehicle door apparatus includes: a first link arm including a proximal end rotatably connected to the vehicle body and a distal end rotatably connected to the door; a second link arm including a proximal end rotatably connected to the vehicle body and a distal end rotatably connected to the door; and a door braking unit disposed on one of the vehicle body and the door, and configured to brake the door by applying braking torque to an end of the first link arm. The first link arm and the second link arm constitute a four-bar linkage mechanism together with the vehicle body and the door. The door braking unit includes a rotating body configured to rotate in response to rotation of the first link arm, and a braking member configured to apply braking torque to the first link arm via the rotating body when engaging with the rotating body. The rotating body transitions from one of an engaged state of engaging with the braking member and a retracted state of not engaging with the braking member to another of the engaged state and the retracted state in response to rotation of the rotating body. The rotating body transitions to the engaged state at least when the door is disposed at a fully open position where the door fully opens the door opening.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a perspective view of a vehicle including a vehicle door apparatus;

FIG. 2 is a perspective view of the vehicle including the vehicle door apparatus;

FIG. 3 is a side view of the vehicle including the vehicle door apparatus;

FIG. 4 is a partial perspective view of the vehicle door apparatus;

FIG. 5 is a partial perspective view of the vehicle door apparatus;

FIG. 6 is a partial exploded perspective view of the vehicle door apparatus;

FIG. 7 is a partial exploded perspective view of the vehicle door apparatus;

FIG. 8 is a partial plan view of the vehicle door apparatus;

FIG. 9 is a partial plan view of the vehicle door apparatus;

FIG. 10 is a partial plan view of the vehicle door apparatus; and

FIG. 11 is a partial plan view of a vehicle door apparatus according to a modification.

### DETAILED DESCRIPTION

An embodiment of a vehicle including a vehicle door apparatus (hereinafter referred to as a “door apparatus”) will be explained.

### Configuration of the Present Embodiment

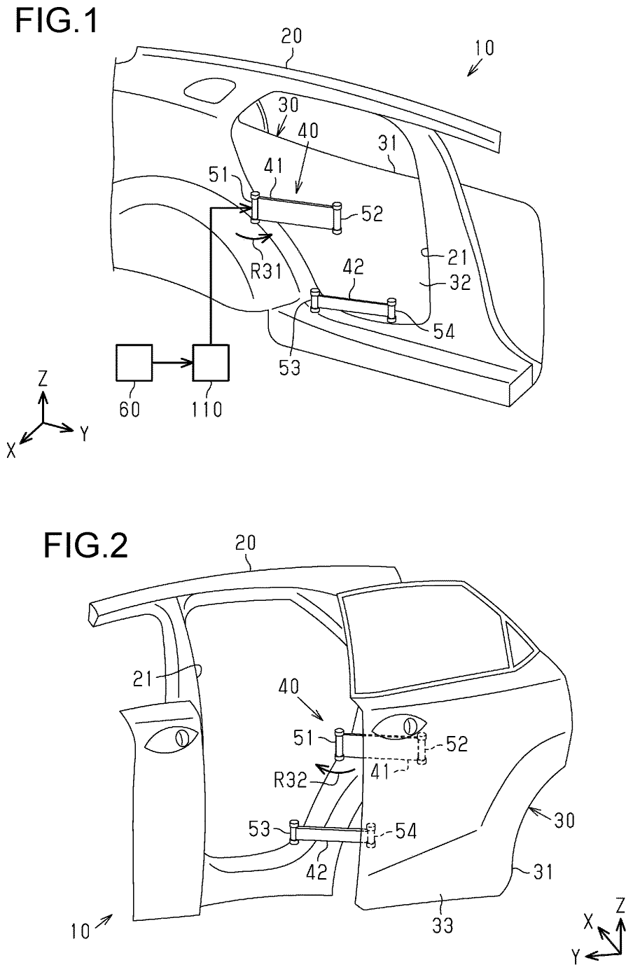

As illustrated in FIG. 1 to FIG. 3, a vehicle 10 includes a vehicle body 20, a door 30, a door apparatus 40, and a door control device 60.

In the following description, the width direction of the vehicle 10, the front-rear direction of the vehicle 10, and the up-down direction of the vehicle 10 are respectively referred to as the width direction, the front-rear direction, and the up-down direction. In the figures, the width direction is a direction in which an X-axis extends, the front-rear direction is a direction in which a Y-axis extends, and the up-down direction is a direction in which a Z-axis extends. Further, in the width direction, a direction toward the center of the vehicle 10 is referred to as the inward direction, and a direction away from the center of the vehicle 10 is referred to as the outward direction.

### Vehicle Body 20

The vehicle body 20 has a door opening 21. The door opening 21 is provided in a side surface in the width direction of the vehicle body 20. The door opening 21 is a region through which a user passes when getting on or off the vehicle 10 into or from a rear seat.

### Door 30

The door 30 has a door body 31. The door body 31 has an inner panel 32 and an outer panel 33. The inner panel 32 and the outer panel 33 are panels matching the shape of the door opening 21. The inner panel 32 is a portion of the door body 31 facing in the inward direction of the vehicle 10, and the outer panel 33 is a portion of the door body 31 facing in the outward direction of the vehicle 10. The inner panel 32 and the outer panel 33 are joined by welding or the like. Hereinafter, a position where the door 30 fully closes the door opening 21 is referred to as a “fully closed position,” and a position where the door 30 fully opens the door opening 21 is referred to as a “fully open position.”

### Door Apparatus 40

As illustrated in FIG. 1 to FIG. 3, the door apparatus 40 includes a first link arm 41, a second link arm 42, two first arm brackets 43 and 44, two second arm brackets 45 and 46, two first support shafts 51 and 52, and two second support shafts 53 and 54. The door apparatus 40 further includes a door drive unit 100 and a door braking unit 200.

### First Link Arm 41 and First Arm Brackets 43, 44

The first link arm 41 is a link arm that defines an opening and closing trajectory of the door 30 and supports the weight of the door 30. The size of the first link arm 41 is larger than that of the second link arm 42. The first link arm 41 has an arm body 411, a proximal-side connecting portion 412, a distal-side connecting portion 413, and a sector gear 414.

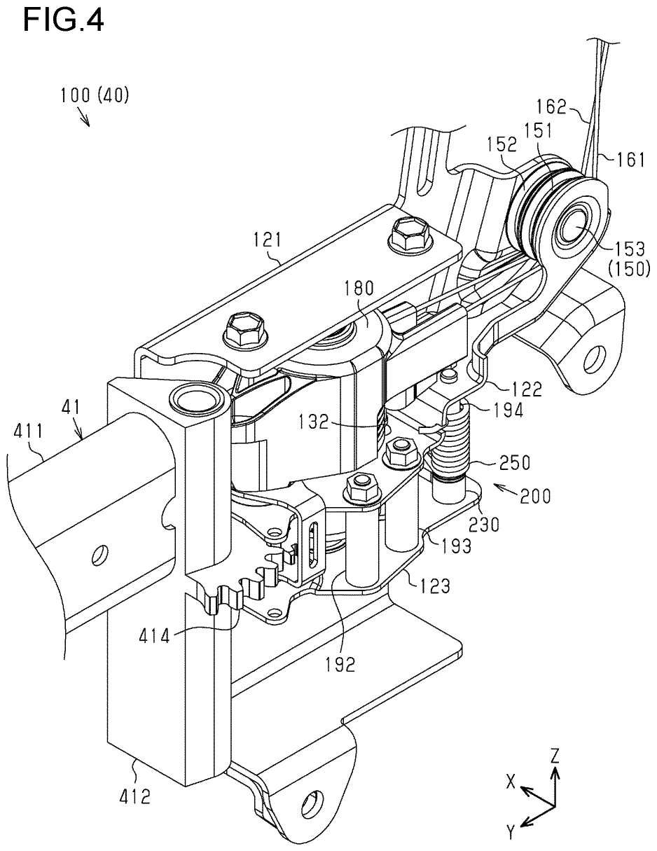

The arm body 411 is rod-shaped. The arm body 411 constitutes a large part of the first link arm 41. The proximal-side connecting portion 412 constitutes a proximal end of the first link arm 41. The distal-side connecting portion 413 constitutes a distal end of the first link arm 41. The proximal-side connecting portion 412 and the distal-side connecting portion 413 are columnar. The height direction of the proximal-side connecting portion 412 and the height direction of the distal-side connecting portion 413 are both vertical. As illustrated in FIG. 4, the sector gear 414 is provided in the proximal-side connecting portion 412. An axis of the sector gear 414 extends in the up-down direction. When the sector gear 414 rotates, the arm body 411 rotates together with the sector gear 414.

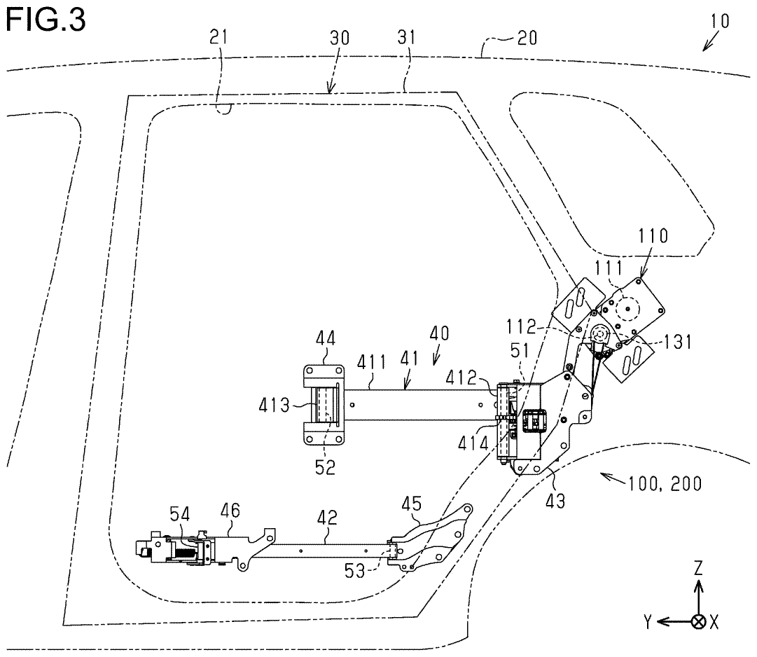

As illustrated in FIG. 3, the first arm bracket 43 supports the first support shaft 51. An axis of the first support shaft 51 extends in the up-down direction. The first arm bracket 43 rotatably supports the proximal-side connecting portion 412 of the first link arm 41 via the first support shaft 51. As a result, the first link arm 41 is rotatable relative to the first arm bracket 43 about the axis of the first support shaft 51. Herein, the axis of the first support shaft 51 coincides with the axis of the sector gear 414. The first arm bracket 43 is fixed to the vehicle body 20 by a fastening member. In the present embodiment, the fastening member may be a screw, a bolt and a nut, or a rivet.

The first arm bracket 44 supports the first support shaft 52. An axis of the first support shaft 52 extends in the up-down direction. The first arm bracket 44 rotatably supports the distal-side connecting portion 413 of the first link arm 41 via the first support shaft 52. As a result, the first link arm 41 is rotatable relative to the first arm bracket 44 about the axis of the first support shaft 52. The first arm bracket 44 is fixed to the door 30 by a fastening member.

### Second Link Arm 42 and Second Arm Brackets 45, 46

Similarly to the first link arm 41, the second link arm 42 is a link arm that defines the opening and closing trajectory of the door 30 and supports the weight of the door 30. One end in a longitudinal direction of the second link arm 42 is a proximal end and the other end in the longitudinal direction of the second link arm 42 is a distal end. The second link arm 42 may be configured in such a way that a length of the second link arm 42 in the longitudinal direction is adjustable. For example, when the door 30 is closed from a near-fully-closed position near the fully closed position to the fully closed position, an orientation of the door 30 at the time of closing can be varied by changing the length of the second link arm 42.

The second arm bracket 45 supports the second support shaft 53. An axis of the second support shaft 53 extends in the up-down direction. The second arm bracket 45 rotatably supports the proximal end of the second link arm 42 via the second support shaft 53. As a result, the second link arm 42 is rotatable relative to the second arm bracket 45 about the axis of the second support shaft 53. The second arm bracket 45 is fixed to the vehicle body 20 by a fastening member.

The second arm bracket 46 supports the second support shaft 54. An axis of the second support shaft 54 extends in the up-down direction. The second arm bracket 46 rotatably supports the distal end of the second link arm 42 via the second support shaft 54. As a result, the second link arm 42 is rotatable relative to the second arm bracket 46 about the axis of the second support shaft 54. The second arm bracket 46 is fixed to the door 30 by a fastening member.

As described above, the proximal end of the first link arm 41 is rotatably connected to the vehicle body 20, while the distal end of the first link arm 41 is rotatably connected to the door 30. Further, the proximal end of the second link arm 42 is rotatably connected to the vehicle body 20, while the distal end of the second link arm 42 is rotatably connected to the door 30. The first link arm 41 and the second link arm 42 constitute a four-bar linkage mechanism together with the vehicle body 20 and the door 30.

### Door Drive Unit 100

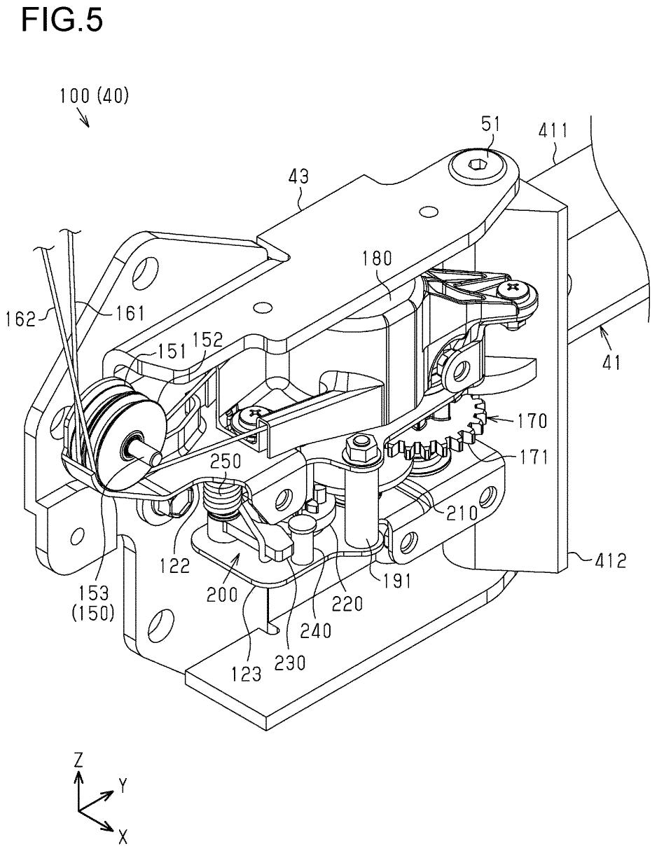

As illustrated in FIG. 3 to FIG. 5, the door drive unit 100 includes an actuator 110, a base bracket 121, an upper bracket 122, a lower bracket 123, and a drive drum 131. As illustrated in FIG. 4 to FIG. 7, the door drive unit 100 further includes a driven drum 132, a main shaft 140, a relay pulley 150, two cables 161 and 162, a drive gear 170, a drum cover 180, and a plurality of connecting shafts 191 to 194. Note that FIG. 4 omits illustration of the first arm bracket 43, and FIG. 5 omits illustration of the base bracket 121. The door drive unit 100 is a mechanism for opening and closing the door 30 by applying driving torque to the end of the first link arm 41. In the present embodiment, the door drive unit 100 is disposed on the vehicle body 20.

As illustrated in FIG. 3, the actuator 110 includes an electric motor 111 and an output shaft 112. The actuator 110 rotates the output shaft 112 by transmitting output torque from the electric motor 111 to the output shaft 112. Although illustration is omitted, the actuator 110 may include a speed reducer between the electric motor 111 and the output shaft 112. The actuator 110 is fixed to the vehicle body 20 by a fastening member.

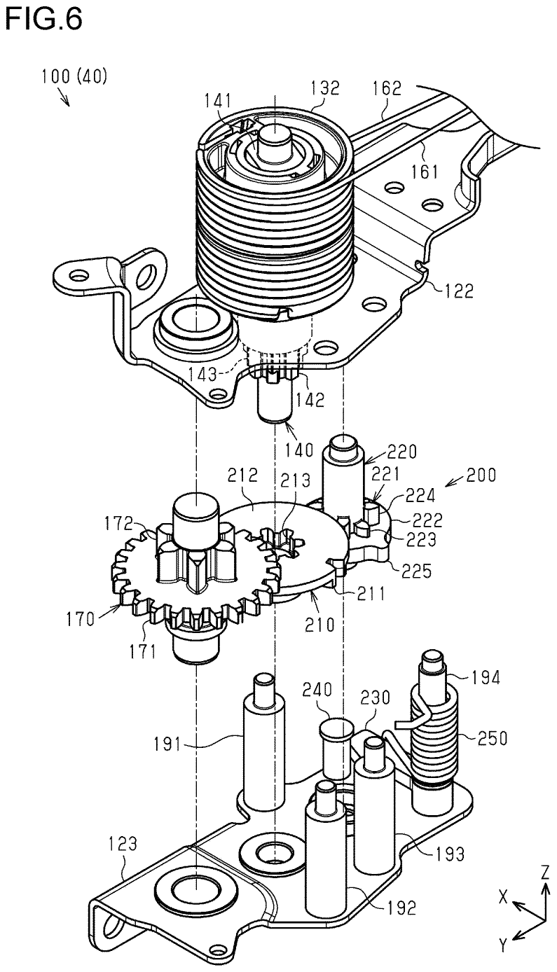

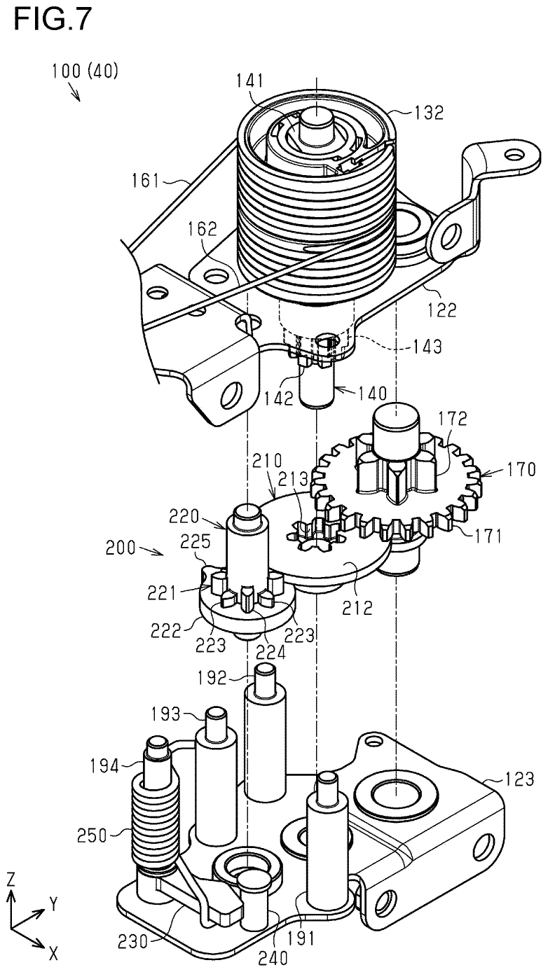

As illustrated in FIG. 4 and FIG. 5, the base bracket 121, the upper bracket 122, and the lower bracket 123 are members supporting components of the door apparatus 40. The base bracket 121 is fixed to the first arm bracket 43 by a fastening member. As illustrated in FIG. 6 and FIG. 7, the upper bracket 122 and the lower bracket 123 are located at a distance in the up-down direction. The upper bracket 122 and the lower bracket 123 are connected by a plurality of the connecting shafts 191 to 194 at a distance in the up-down direction. The upper bracket 122 and the lower bracket 123 are fixed to the base bracket 121 by a fastening member.

As illustrated in FIG. 3, the drive drum 131 is cylindrical. A spiral groove is provided on an outer peripheral surface of the drive drum 131. The output shaft 112 of the actuator 110 is fixed to the drive drum 131. Therefore, the drive drum 131 rotates together with the output shaft 112. As illustrated in FIG. 6 and FIG. 7, the driven drum 132 is cylindrical. A diameter of the driven drum 132 is larger than that of the drive drum 131. A spiral groove is provided on an outer peripheral surface of the driven drum 132. As illustrated in FIG. 4 and FIG. 5, the driven drum 132 is covered by the drum cover 180.

As illustrated in FIG. 6 and FIG. 7, the main shaft 140 is rod-shaped. The main shaft 140 has a first engaging shaft portion 141, a second engaging shaft portion 142, and an input gear 143. Cross-sectional shapes taken orthogonal to an axial direction of the first engaging shaft portion 141 and the second engaging shaft portion 142 are non-circular. The input gear 143 is located between the first engaging shaft portion 141 and the second engaging shaft portion 142 in the axial direction. The main shaft 140 extends through the driven drum 132 in the axial direction. In this state, the first engaging shaft portion 141 of the main shaft 140 is engaged with the driven drum 132. Thus, the main shaft 140 is rotatable together with the driven drum 132.

One end of the main shaft 140 in an axial direction is rotatably supported by the drum cover 180, and the other end of the main shaft 140 in the axial direction is rotatably supported by the lower bracket 123. Both ends of the main shaft 140 in the axial direction may be supported by the drum cover 180 and the lower bracket 123 via bearings, respectively. Thus, the driven drum 132 and the input gear 143 are rotatable about an axis extending in the up-down direction. A rotation axis of the driven drum 132 and the input gear 143 is skew to a rotation axis of the drive drum 131.

As illustrated in FIG. 4 and FIG. 5, the relay pulley 150 includes a first pulley 151, a second pulley 152, and a pulley support shaft 153. The first pulley 151 and the second pulley 152 are rotatably supported by the pulley support shaft 153. The first pulley 151 and the second pulley 152 are rotatable in mutually different directions. One end of the pulley support shaft 153 in an axial direction is supported by the upper bracket 122, and the other end of the pulley support shaft 153 in the axial direction is supported by the base bracket 121. An axis of the pulley support shaft 153 extends in the width direction. In this respect, the axis of the pulley support shaft 153 is parallel to the axis of the drive drum 131. In contrast, the axis of the pulley support shaft 153 is skew to the axis of the driven drum 132.

The first cable 161 and the second cable 162 are cables for power transmission. Both ends of the first cable 161 are respectively wound around the drive drum 131 and the driven drum 132. Similarly, both ends of the second cable 162 are respectively wound around the drive drum 131 and the driven drum 132. Further, an intermediate portion of the first cable 161 is wound around the first pulley 151, and an intermediate portion of the second cable 162 is wound around the second pulley 152.

As illustrated in FIG. 6 to FIG. 8, the drive gear 170 has a first drive gear 171 and a second drive gear 172. In the present embodiment, the first drive gear 171 and the second drive gear 172 constitute a two-stage gear. A pitch circle diameter of the first drive gear 171 is larger than that of the input gear 143 of the main shaft 140 and is larger than that of the second drive gear 172. In other words, the number of teeth of the first drive gear 171 is greater than that of the input gear 143 of the main shaft 140 and is greater than that of the second drive gear 172. Meanwhile, the pitch circle diameter of the second drive gear 172 is smaller than that of the sector gear 414 of the first link arm 41. One end of the drive gear 170 in an axial direction is rotatably supported by the upper bracket 122, and the other end of the drive gear 170 in the axial direction is rotatably supported by the lower bracket 123. Both ends of the drive gear 170 in the axial direction may be supported by the upper bracket 122 and the lower bracket 123 via bearings.

The first drive gear 171 meshes with the input gear 143 of the main shaft 140, and the second drive gear 172 meshes with the sector gear 414 of the first link arm 41. In this manner, the drive gear 170 transmits torque between the input gear 143 and the first link arm 41. Thus, torque for rotating the first link arm 41 about the axis of the first support shaft 51 is applied to the proximal end of the first link arm 41. In the present embodiment, the rotation speeds of the driven drum 132 and the input gear 143 are reduced relative to that of the drive drum 131. Further, the rotation speed of the drive gear 170 is reduced relative to that of the input gear 143. Further, the rotation speed of the first link arm 41 is reduced relative to that of the drive gear 170. In these respects, the drive drum 131, the driven drum 132, the input gear 143, and the drive gear 170 correspond to “transmission elements” configured to amplify output torque from the electric motor 111 and transmit the amplified output torque to the first link arm 41.

### Door Braking Unit 200

As illustrated in FIG. 6 to FIG. 8, the door braking unit 200 includes a first transmission unit 210, a second transmission unit 220, a braking lever 230, a stopper 240, and a biasing member 250. The door braking unit 200 is a mechanism for braking the door 30 by applying braking torque to the end of the first link arm 41. More specifically, the door braking unit 200 is a mechanism for holding the door 30 at the fully open position. In the present embodiment, the door braking unit 200 is disposed on the vehicle body 20.

The first transmission unit 210 has a first braking gear 211, a rotation restricting portion 212, and an engaging hole 213. The first braking gear 211 is an intermittent gear. The first braking gear 211 has a plurality of tooth elements 214. In the present embodiment, the total number of the tooth elements 214 of the first braking gear 211, that is, the number of teeth of the first braking gear 211 is “2.” Assuming that the first braking gear 211 is not an intermittent gear but a normal gear in which the tooth elements 214 are provided at a constant pitch, the number of teeth of the gear would be “20.” The rotation restricting portion 212 is disk-shaped. An outer diameter of the rotation restricting portion 212 is equal to an addendum circle diameter of the first braking gear 211. The rotation restricting portion 212 is integral with the first braking gear 211. The rotation restricting portion 212 has retraction grooves 215. The retraction grooves 215 are provided at portions overlapping with tooth spaces between the two tooth elements 214 in a circumferential direction of the rotation restricting portion 212. That is, the retraction groove 215 may be regarded as a groove having a shape corresponding to an axial projection of the tooth space between the two tooth elements 214 onto the rotation restricting portion 212 in the axial direction. The engaging hole 213 extends through the first transmission unit 210 in the axial direction. A cross-sectional shape taken orthogonal to the axial direction of the engaging hole 213 is non-circular.

The main shaft 140 extends through the first transmission unit 210. In this state, the second engaging shaft portion 142 of the main shaft 140 is engaged with the first transmission unit 210. With this configuration, the first transmission unit 210 is integral with the main shaft 140. That is, a rotation axis of the first transmission unit 210 coincides with a rotation axis of the main shaft 140. Furthermore, the first braking gear 211 is rotatable together with the main shaft 140. That is, the first braking gear 211 rotates together with the driven drum 132 and the input gear 143 each corresponding to “one of the transmission elements.”

The second transmission unit 220 has a second braking gear 221 and a rotating body 222. The number of teeth of the second braking gear 221 is “8.” A pitch circle diameter of the second braking gear 221 is smaller than that of the first braking gear 211. The second braking gear 221 has a plurality of first tooth elements 223 and a plurality of second tooth elements 224. A face width of the first tooth element 223 is shorter than that of the second tooth element 224. The face width of the first tooth element 223 is substantially equal to that of the tooth element 214 of the first braking gear 211. The face width of the second tooth element 224 is substantially equal to the sum of the face width of the tooth element 214 of the first braking gear 211 and a width of the rotation restricting portion 212. The total number of the first tooth elements 223 and the total number of the second tooth elements 224 are both “4.” In a circumferential direction of the second braking gear 221, a plurality of the first tooth elements 223 and a plurality of the second tooth elements 224 are arranged alternately at equal intervals. The rotating body 222 is disk-shaped. The rotating body 222 has an engaging protrusion 225 protruding outward in a radial direction of the rotating body 222. That is, the protruding direction of the engaging protrusion 225 is a direction intersecting a rotation direction of the rotating body 222. The rotating body 222 is integral with the second braking gear 221.

One end of the second transmission unit 220 in an axial direction is rotatably supported by the upper bracket 122, and the other end of the second transmission unit 220 in the axial direction is rotatably supported by the lower bracket 123. Both ends of the second transmission unit 220 in the axial direction may be supported by the upper bracket 122 and the lower bracket 123 via bearings. A plurality of the first tooth elements 223 of the second braking gear 221 overlap the first braking gear 211 at the same axial level, but do not overlap the rotation restricting portion 212. That is, the first tooth elements 223 of the second braking gear 221 can mesh with the first braking gear 211, but cannot engage with the rotation restricting portion 212. Meanwhile, a plurality of the second tooth elements 224 of the second braking gear 221 overlap both the first braking gear 211 and the rotation restricting portion 212 at the same axial level. That is, the second tooth elements 224 of the second braking gear 221 can mesh with the first braking gear 211 and are engageable with the rotation restricting portion 212.

The braking lever 230 is rod-shaped. The braking lever 230 has a first sliding surface 231 and a second sliding surface 232. The first sliding surface 231 and the second sliding surface 232 are flat surfaces. The first sliding surface 231 and the second sliding surface 232 are inclined in different directions. The first sliding surface 231 is located closer to a distal end of the braking lever 230 than the second sliding surface 232. A proximal end of the braking lever 230 is rotatably supported by the connecting shaft 194. The braking lever 230 corresponds to the “braking member” configured to apply braking torque to the rotating body 222 when engaging with the engaging protrusion 225 of the rotating body 222.

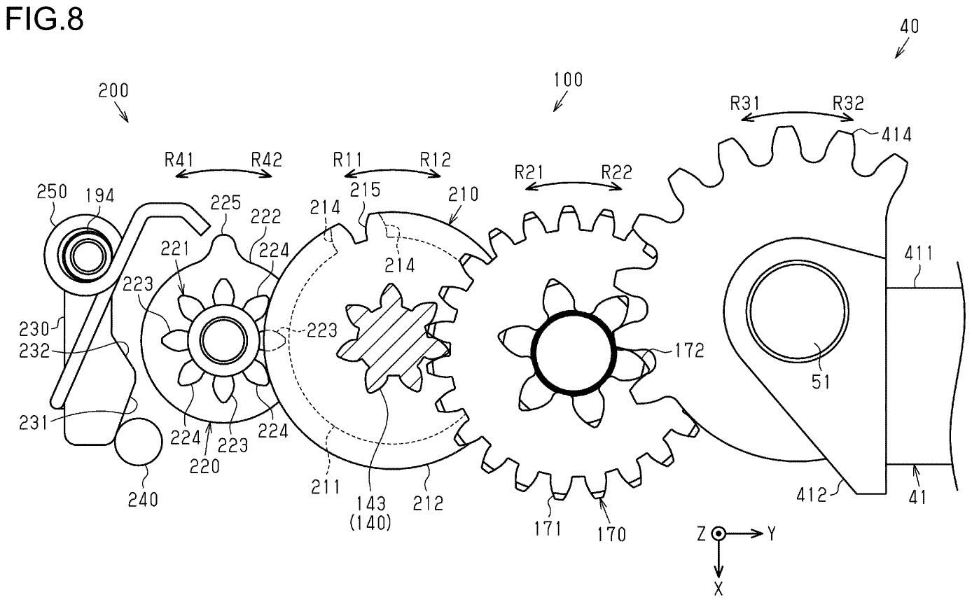

The stopper 240 is cylindrical. A proximal end of the stopper 240 is fixed to the lower bracket 123. The biasing member 250 is a torsion spring. The connecting shaft 194 is inserted into a coil portion of the biasing member 250. A first end of the biasing member 250 is anchored to the braking lever 230, while a second end of the biasing member 250 is anchored to the upper bracket 122. Thus, the biasing member 250 biases the braking lever 230 in a direction approaching the rotating body 222. However, in FIG. 8, the braking lever 230 is positioned by contacting the stopper 240. The biasing member 250 may be a coil spring or another elastic body.

### Door Control Device 60

The door control device 60 is a processing circuit including a CPU and a ROM. The door control device 60 opens or closes the door 30 by controlling the door drive unit 100. For example, the door control device 60 receives a request to open or close the door 30 when a user operates a mobile device or a door handle. When receiving a request to open the door 30, the door control device 60 controls the door drive unit 100 to open the door 30. Meanwhile, when receiving a request to close the door 30, the door control device 60 controls the door drive unit 100 to close the door 30.

### Operations in the Present Embodiment

The operation of opening the door 30 will be described.

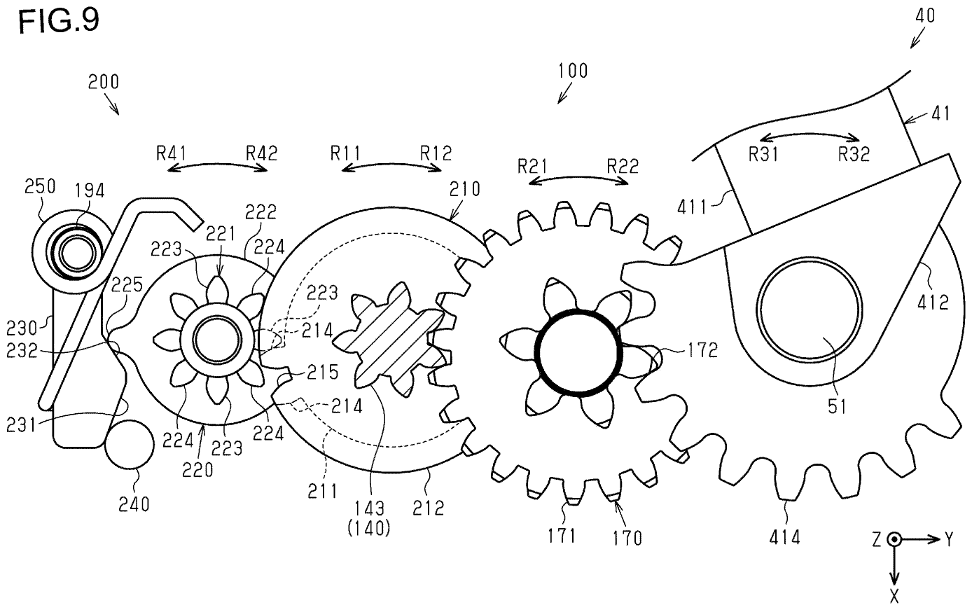

As illustrated in FIG. 8, when the door 30 is opened from the fully closed position, the drive drum 131 is driven by the actuator 110. Then, the drive drum 131 winds the first cable 161, and the second cable 162 is paid out from the drive drum 131. Meanwhile, the first cable 161 is paid out from the driven drum 132, and the driven drum 132 winds the second cable 162. As a result, the driven drum 132 rotates in a first rotation direction R11. Subsequently, when the driven drum 132 rotates in the first rotation direction R11, driving torque is transmitted from the input gear 143 to the first drive gear 171. Thus, the drive gear 170 rotates in a second rotation direction R22. Subsequently, the driving torque is transmitted from the second drive gear 172 to the sector gear 414. Thus, the first link arm 41 rotates in a first rotation direction R31. As a result, the door 30 opens from the fully closed position illustrated in FIG. 8 toward the fully open position illustrated in FIG. 9. Thus, when the door 30 is opened, the driving torque in the first rotation direction R31 is applied to the proximal end of the first link arm 41 by the door drive unit 100.

The operation of holding the door 30 at the fully open position will be described.

As illustrated in FIG. 8, when the door 30 is disposed at the fully closed position, the engaging protrusion 225 of the rotating body 222 is separated from the braking lever 230. That is, the rotating body 222 is in a retracted state of not engaging with the braking lever 230. Therefore, no friction force is generated between the engaging protrusion 225 of the rotating body 222 and the braking lever 230. Therefore, braking torque resulting from the friction force acts neither on the rotating body 222 nor on the proximal end of the first link arm 41.

As described above, when the door 30 is opened from the fully closed position to the fully open position, the first braking gear 211 rotates in the first rotation direction R11 together with the driven drum 132. In the present embodiment, when the door 30 is opened from the fully closed position to the fully open position, the first braking gear 211 makes approximately 3.5 revolutions in the first rotation direction R11. However, since the first braking gear 211 is an intermittent gear, the driving torque is transmitted from the first braking gear 211 to the second braking gear 221 only when the tooth element 214 of the first braking gear 211 meshes with the second braking gear 221. In the present embodiment, when the first braking gear 211 makes one revolution in the first rotation direction R11, the second braking gear 221 and the rotating body 222 makes approximately ¼ of a revolution in a second rotation direction R42. In these respects, the rotating body 222 rotates intermittently in response to rotation of the first link arm 41.

In a state where the two tooth elements 214 of the first braking gear 211 do not mesh with the second braking gear 221, the second braking gear 221 does not rotate. If torque acts on the second braking gear 221 in the state where the two tooth elements 214 of the first braking gear 211 do not mesh with the second braking gear 221, the second tooth element 224 of the second braking gear 221 hits the rotation restricting portion 212 of the first braking gear 211. Therefore, in the state where the two tooth elements 214 of the first braking gear 211 do not mesh with the second braking gear 221, rotation of the second braking gear 221 is restricted.

When the door 30 is opened to a near-fully-open position near the fully open position, the engaging protrusion 225 of the rotating body 222 rotating in the second rotation direction R42 contacts the first sliding surface 231 of the braking lever 230. That is, the rotating body 222 transitions from the retracted state to an engaged state of engaging with the braking lever 230. Therefore, friction force is generated between the engaging protrusion 225 of the rotating body 222 and the braking lever 230. Therefore, braking torque resulting from the friction force starts to act on the rotating body 222 and the proximal end of the first link arm 41. The near-fully-open position may be a position of the door 30 where, for example, an opening degree of the door 30 is 80% or more and less than 100%, assuming that the opening degree of the door 30 at the fully open position is 100%.

When the operation of opening the door 30 is continued even after the door 30 reaches the near-fully-open position, the engaging protrusion 225 of the rotating body 222 slides on the first sliding surface 231 of the braking lever 230. At this time, the braking lever 230 rotates in a direction moving away from a rotation axis of the rotating body 222. Thereafter, the engaging protrusion 225 of the rotating body 222 finishes sliding on the first sliding surface 231 of the braking lever 230 and starts sliding on the second sliding surface 232 of the braking lever 230. At this time, the braking lever 230 rotates in a direction approaching the rotation axis of the rotating body 222.

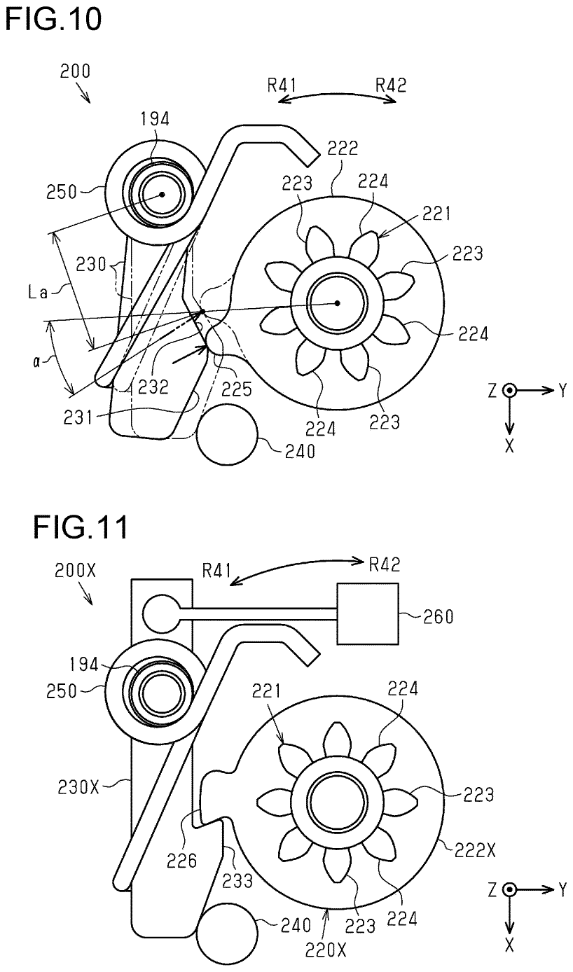

As illustrated by a solid line and a two-dot chain line in FIG. 10, when the engaging protrusion 225 of the rotating body 222 slides on the second sliding surface 232 of the braking lever 230, a direction in which the friction force generated between the engaging protrusion 225 and the second sliding surface 232 acts changes as the rotating body 222 rotates in the second rotation direction R42. More specifically, a pressure angle α increases as the rotating body 222 rotates in the second rotation direction R42. As a result, due to the engagement between the rotating body 222 and the braking lever 230, among force acting on the rotating body 222, a ratio of a component contributing to the braking torque acting in the second rotation direction R42 of the rotating body 222 increases. Accordingly, with the pressure angle α thus increased, the braking torque in the second rotation direction R42 acting on the rotating body 222 increases. Note that the pressure angle α is an angle formed between a straight line passing through a contact point between the rotating body 222 and the braking lever 230 and the rotation axis of the rotating body 222, and a straight line perpendicular to the second sliding surface 232 of the braking lever 230.

Further, when the engaging protrusion 225 of the rotating body 222 slides on the second sliding surface 232 of the braking lever 230, a distance La from a rotation axis of the braking lever 230 to a contact point with the engaging protrusion 225 on the second sliding surface 232 gradually decreases as the rotating body 222 rotates in the second rotation direction R42. In other words, in the braking lever 230, a portion on which the engaging protrusion 225 of the rotating body 222 slides changes from the distal end toward the proximal end of the braking lever 230. As a result, when the engaging protrusion 225 of the rotating body 222 slides on the second sliding surface 232 of the braking lever 230, force with which the braking lever 230 pushes the rotating body 222 increases as the rotating body 222 rotates in the second rotation direction R42. Thus, as the distance La serving as a moment arm decreases, the braking torque in the second rotation direction R42 acting on the rotating body 222 increases.

As illustrated in FIG. 9, when the door 30 is disposed at the fully open position, torque is no longer output from the electric motor 111 of the door drive unit 100. Herein, the door control device 60 may stop the operation of the actuator 110 based on, for example, an increase in load on the electric motor 111 accompanying an increase in braking torque. Thus, rotation of the rotating body 222 in the first rotation direction R41 is stopped. As described above, the braking torque in the second rotation direction R42 acts on the rotating body 222 by the braking lever 230 pushing the engaging protrusion 225. The braking torque acting on the rotating body 222 in the second rotation direction R42 acts on the first link arm 41 in the first rotation direction R31 via the second braking gear 221, the first braking gear 211, the input gear 143, the first drive gear 171, and the second drive gear 172. That is, the braking torque by the door braking unit 200 acts in an opening direction of the door 30. Thus, as a result of maintaining the state in which the rotating body 222 is stopped, the door 30 is held at the fully open position.

In the present embodiment, the braking torque applied to the rotating body 222 is amplified when transmitted from the second braking gear 221 to the first braking gear 211. Furthermore, the braking torque is amplified when transmitted from the input gear 143 rotating coaxially with the first braking gear 211 to the first drive gear 171. Furthermore, the braking torque is amplified when transmitted from the second drive gear 172 to the sector gear 414. Therefore, even when the force with which the braking lever 230 pushes the rotating body 222 is small, the braking torque acting on the first link arm 41 becomes high. In other words, a spring constant of the biasing member 250, a preload on the biasing member 250, a friction coefficient between the engaging protrusion 225 of the rotating body 222 and the braking lever 230, a torque multiplication ratio between the second braking gear 221 and the sector gear 414, and the like are set to values that allow the door 30 to be held at the fully open position.

In the present embodiment, the main shaft 140 makes approximately 3.5 revolutions until the door 30 opens from the fully closed position to the fully open position. In contrast, the first link arm 41 makes approximately ⅓ of a revolution. Further, the rotating body 222 makes approximately ¾ of a revolution. That is, a rotation amount of the rotating body 222 is less than 360 degrees. Therefore, the rotating body 222 enters the engaged state only once while the door 30 opens from the fully closed position to the fully open position.

The operation of closing the door 30 will be described.

As illustrated in FIG. 9, when closing the door 30 from the fully open position, the actuator 110 drives the drive drum 131 in a direction opposite to the direction in which opening the door 30 is opened. Then, the drive drum 131 winds the second cable 162, and the first cable 161 is paid out from the drive drum 131. Meanwhile, the driven drum 132 winds the first cable 161, and the second cable 162 is paid out from the driven drum 132. As a result, the driven drum 132 attempts to rotate in the second rotation direction R12.

When the driven drum 132 attempts to rotate in the second rotation direction R12, driving torque in the first rotation direction R41 is transmitted to the second braking gear 221 via the first braking gear 211. When the driving torque acting on the second braking gear 221 becomes greater than the braking torque acting on the second braking gear 221, the second braking gear 221 starts rotating in the first rotation direction R41. That is, the driven drum 132 starts rotating in the second rotation direction R12.

When the driven drum 132 rotates in the second rotation direction R12, driving torque is transmitted from the input gear 143 to the first drive gear 171. Thus, the drive gear 170 rotates in a first rotation direction R21. Subsequently, the driving torque is transmitted from the second drive gear 172 to the sector gear 414. In this manner, the door drive unit 100 applies, to the first link arm 41, the driving torque that rotates the first link arm 41 in the second rotation direction R32. As a result, the rotation of the first link arm 41 in the second rotation direction R32 causes the door 30 to close from the fully open position illustrated in FIG. 9 toward the fully closed position illustrated in FIG. 8.

When the door 30 moves from the fully open position to the near-fully-open position, the engaging protrusion 225 of the rotating body 222 first slides on the second sliding surface 232 of the braking lever 230, and then slides on the first sliding surface 231. When the door 30 moves in the closing direction from the near-fully-open position, the engaging protrusion 225 of the rotating body 222 moves away from the braking lever 230. That is, the state of the rotating body 222 transitions from the engaged state to the retracted state, whereby the braking torque applied to the rotating body 222 is eliminated.

### Effects of the Present Embodiment

(1) When the door 30 is disposed at the fully open position, the door apparatus 40 applies braking torque to the rotating body 222 by transitioning the rotating body 222 to the engaged state. In this manner, the door apparatus 40 can hold the door 30 at the fully open position. Further, in the door apparatus 40, components of the door braking unit 200 are concentrated at the proximal end of the first link arm 41. In other words, components of the door braking unit 200 are not arranged separately at various portions of the door apparatus 40. In this respect, the door apparatus 40 prevents the mechanism for holding the door 30 at the fully open position from becoming complicated.

(2) The door apparatus 40 includes the door drive unit 100 configured to open and close the door 30 by applying driving torque to the proximal end of the first link arm 41. In the door apparatus 40, the door braking unit 200 is disposed near the door drive unit 100. Therefore, the door apparatus 40 prevents an increase in the size of the apparatus in that the door drive unit 100 and the door braking unit 200 are collectively arranged at a single location.

(3) The door apparatus 40 can avoid applying braking torque to the rotating body 222 periodically according to a rotation cycle of the rotating body 222 by setting the rotation amount of the rotating body 222 when the door 30 is opened from the fully closed position to the fully open position to be less than 360 degrees. In other words, the door apparatus 40 can apply braking torque to the rotating body 222 only when the door 30 is disposed at the fully open position.

(4) In a comparative example in which the first braking gear 211 is not an intermittent gear, in order to make the rotation amount of the rotating body 222 less than 360 degrees during the opening and closing operation of the door 30, it is necessary to increase the number of teeth of the second braking gear 221. In this case, the second braking gear 221 tends to increase in size. In contrast, in the door apparatus 40 of the present embodiment, the first braking gear 211 is an intermittent gear. Therefore, even without increasing the size of the second braking gear 221, it is easy to make the rotation amount of the rotating body 222 less than 360 degrees during the opening and closing operation of the door 30.

(5) When the pitch circle diameter of the second braking gear 221 is larger than that of the first braking gear 211, the braking torque applied to the rotating body 222 is not amplified when transmitted to the first braking gear 211. In contrast, in the present embodiment, the pitch circle diameter of the first braking gear 211 is larger than that of the second braking gear 221. Therefore, the braking torque applied to the rotating body 222 is amplified when transmitted to the first braking gear 211. Thus, the door apparatus 40 can maintain the position of the door 30 even when the braking torque applied to the rotating body 222 is small.

(6) When the door 30 opens from the near-fully-open position to the fully open position, the door apparatus 40 can increase the braking torque applied to the rotating body 222 by changing an engagement relationship between the rotating body 222 and the braking lever 230. More specifically, when the door 30 opens from the near-fully-open position to the fully open position, the door apparatus 40 can increase the braking torque applied to the rotating body 222 by decreasing the distance La. Further, when the door 30 opens from the near-fully-open position to the fully open position, the door apparatus 40 can increase the braking torque applied to the rotating body 222 by increasing the pressure angle α. In these respects, the door apparatus 40 allows the braking torque applied to the rotating body 222 to gradually increase.

### Modifications

The present embodiment can be implemented with the following modifications. The present embodiment and the following modifications may be implemented in combination with each other as long as they are technically consistent.

As illustrated in FIG. 11, a door braking unit 200X according to a modification includes a second transmission unit 220X, a braking lever 230X, a stopper 240, a biasing member 250, and a release member 260. A rotating body 222X of the second transmission unit 220X has a claw-shaped engaging protrusion 226. The engaging protrusion 226 projects in a radial direction of the rotating body 222X. The braking lever 230X has an engaging portion 233 protruding in a direction intersecting a longitudinal direction of the braking lever 230X. The braking lever 230X rotates between an engaged position of engaging with the engaging protrusion 226 of the rotating body 222X and a retracted position of retracting from the engaging protrusion 226 of the rotating body 222X. The biasing member 250 biases the braking lever 230X from the retracted position toward the engaged position. The release member 260 is a member configured to apply a load to the braking lever 230X electrically or manually. The release member 260 displaces the braking lever 230X from the engaged position toward the retracted position against biasing force of the biasing member 250 by applying the load to the braking lever 230X.

When the door 30 is opened to the near-fully-open position, the engaging protrusion 226 of the rotating body 222X does not engage with the engaging portion 233 of the braking lever 230X. Therefore, the state of the rotating body 222X is a retracted state in which no braking torque is applied to the rotating body 222X. Subsequently, when the door 30 is opened from the near-fully-open position to the fully open position, the engaging protrusion 226 of the rotating body 222X slides on the engaging portion 233 of the braking lever 230X. At this time, the braking lever 230X rotates in a direction moving away from a rotation axis of the rotating body 222X in response to rotation of the rotating body 222X in the second rotation direction R42. When the door 30 is opened to the fully open position, the braking lever 230X rotates in a direction approaching the rotation axis of the rotating body 222X, causing the engaging portion 233 of the braking lever 230X to engage with the engaging protrusion 226 of the rotating body 222X. As a result, the rotating body 222X transitions from the retracted state to the engaged state, whereby rotation of the rotating body 222X in the first rotation direction R41 is restricted. In other words, rotation of the door 30 in a closing direction is restricted.

When the door 30 is closed from the fully open position, first, the release member 260 is driven. That is, the release member 260 displaces the braking lever 230X from the engaged position to the retracted position by rotating the braking lever 230X in a direction moving away from the rotating body 222X. Thus, the rotating body 222 transitions from the engaged state to the retracted state, allowing rotation of the rotating body 222 in the first rotation direction R41. In other words, rotation of the door 30 in the closing direction is allowed. Therefore, the door 30 is opened by the door drive unit 100.

In the above-described modification, the release member 260 may be a solenoid actuator. In this case, the release member 260 does not transmit power to the braking lever 230X when not energized. Meanwhile, when energized, the solenoid actuator rotates the braking lever 230X from the engaged position to the retracted position by transmitting power to the braking lever 230X.

In the above-described modification, the release member 260 may be a release cable. The release cable rotates the braking lever 230X from the engaged position to the retracted position by pulling the braking lever 230X. The release cable is pulled, for example, when a user operates a door handle or is pulled by an operation of a release actuator (not illustrated).

In the door braking unit 200, a mechanism configured to intermittently transmit torque from the first braking gear 211 to the second braking gear 221 can be realized by other mechanisms. For example, such a mechanism may be a Geneva mechanism having a pin gear and a Geneva gear, or may be a rack and pinion mechanism.

The first braking gear 211 may be a normal gear that is not an intermittent gear. In this case, the rotating body 222 may rotate 360 degrees or more when the door 30 moves from one of the fully closed position and the fully open position to the other of the fully closed position and the fully open position.

A pitch circle diameter of the second braking gear 221 may be equal to or larger than that of the first braking gear 211. That is, the torque transmitted from the second braking gear 221 to the first braking gear 211 does not have to be amplified.

In the rotating body 222, the protruding direction of the engaging protrusion 225 may be the thickness direction of the rotating body 222.

The rotating body 222 may have an engaging recess recessed inward in the radial direction instead of the engaging protrusion 225. In this modification, braking torque may be applied to the rotating body 222 by engaging the braking lever 230 with the engaging recess of the rotating body 222.

The braking lever 230 may be a braking member that does not rotate about the axis of the connecting shaft 194. For example, the braking lever 230 may be a linearly moving braking member.

In the braking lever 230, inclinations of the first sliding surface 231 and the second sliding surface 232 can be set as appropriate. Further, the braking lever 230 does not have to have the first sliding surface 231.

In the braking lever 230, the manner in which the pressure angle α and the distance La vary when the door 30 is opened may be modified as appropriate.

The braking lever 230 may apply braking torque to the rotating body 222 by pushing the rotating body 222 in the thickness direction or sandwiching the rotating body 222 in the thickness direction.

The door apparatus 40 does not have to include the door drive unit 100. In this case, the user may manually open and close the door 30.

The rotating body 222 may have a plurality of engaging protrusions 225. In this case, intervals at which a plurality of the engaging protrusions 225 are formed in the circumferential direction of the rotating body 222 may be determined according to an opening degree at which the door 30 is desired to be held.

In the embodiment described above, the door braking unit 200 is disposed on the vehicle body 20 in such a way as to allow application of braking torque to the proximal end of the first link arm 41. In a modification, the door braking unit 200 may be disposed on the door 30 in such a way as to allow application of braking torque to the distal end of the first link arm 41. Further, the door braking unit 200 may be disposed on the vehicle body 20 in such a way as to allow application of braking torque to the proximal end of the second link arm 42, or may be disposed on the door 30 in such a way as to allow application of braking torque to the distal end of the second link arm 42.

The door drive unit 100 may be configured to apply driving torque to an end of the first link arm 41. For example, the door drive unit 100 may be configured to transmit torque only by a plurality of gears without using the cables 161 and 162. Further, the door drive unit 100 may be configured to apply driving torque to an end of the second link arm 42.

The door 30 may be a front door or another door.

### Summary of the Present Embodiment

A vehicle door apparatus to be applied to a vehicle including a vehicle body having a door opening and a door configured to open and close the door opening includes: a first link arm including a proximal end rotatably connected to the vehicle body and a distal end rotatably connected to the door; a second link arm including a proximal end rotatably connected to the vehicle body and a distal end rotatably connected to the door; and a door braking unit disposed on one of the vehicle body and the door, and configured to brake the door by applying braking torque to an end of the first link arm. The first link arm and the second link arm constitute a four-bar linkage mechanism together with the vehicle body and the door. The door braking unit includes a rotating body configured to rotate in response to rotation of the first link arm, and a braking member configured to apply braking torque to the first link arm via the rotating body when engaging with the rotating body. The rotating body transitions from one of an engaged state of engaging with the braking member and a retracted state of not engaging with the braking member to another of the engaged state and the retracted state in response to rotation of the rotating body. The rotating body transitions to the engaged state at least when the door is disposed at a fully open position where the door fully opens the door opening.

The vehicle door apparatus causes the rotating body that rotates together with the first link arm, to transition from one of the engaged state and the retracted state to another state in response to rotation of the rotating body when opening and closing the door. In other words, the vehicle door apparatus switches between a state of braking the door and a state of not braking the door in response to rotation of the rotating body rotating together with the first link arm when opening and closing the door. When the door is disposed at the fully open position, the vehicle door apparatus holds the door by causing the rotating body to transition to the engaged state.

In the vehicle door apparatus, since the door braking unit is configured to apply braking torque to the rotating body rotating in response to rotation of the first link arm, it is easy to concentrate, at a location such as the proximal end or the distal end of the first link arm, the mechanism for holding the door at the fully open position. In this respect, the vehicle door apparatus prevents the mechanism for holding the door at the fully open position from becoming complicated since it is not necessary to arrange components separately at a plurality of locations.

The vehicle door apparatus may further include a door drive unit to be disposed on one of the vehicle body and the door together with the door braking unit, and configured to open and close the door by applying driving torque to the end of the first link arm, wherein the door drive unit may include an electric motor and a plurality of transmission elements configured to amplify output torque from the electric motor and transmit the amplified output torque to the first link arm. The door braking unit may include a first braking gear configured to rotate together with any one of a plurality of the transmission elements, and a second braking gear configured to rotate together with the rotating body and mesh with the first braking gear.

In the vehicle door apparatus, the door braking unit is disposed near the door drive unit. Therefore, the vehicle door apparatus prevents an increase in size of the apparatus by concentrating the door drive unit and the door braking unit.

In the vehicle door apparatus, a position where the door fully closes the door opening is a fully closed position, and a rotation amount of the rotating body when the door moves from one of the fully closed position and the fully open position to another of the fully closed position and the fully open position may be less than 360 degrees. The first braking gear may be an intermittent gear configured to intermittently transmit torque to the second braking gear.

By setting the rotation amount of the rotating body to be less than 360 degrees, the vehicle door apparatus can avoid applying braking torque to the rotating body according to a rotation cycle of the rotating body. In other words, the vehicle door apparatus can apply braking torque to the rotating body only when the door is disposed at the fully open position.

Herein, in a comparative example in which the first braking gear is not an intermittent gear, in order to make the rotation amount of the rotating body less than 360 degrees during opening and closing operation of the door, it is necessary to increase the number of teeth of the second braking gear. In this respect, the second braking gear tends to increase in size. In contrast, in the vehicle door apparatus having the above-described configuration, the first braking gear is an intermittent gear. Therefore, even without increasing the size of the second braking gear, it is easy to make the rotation amount of the rotating body less than 360 degrees during opening and closing operation of the door.

In the vehicle door apparatus, a pitch circle diameter of the second braking gear may be smaller than that of the first braking gear.

When the pitch circle diameter of the second braking gear is larger than that of the first braking gear, the braking torque applied to the rotating body is not amplified when transmitted to the first braking gear. In contrast, in the above-described configuration, the pitch circle diameter of the second braking gear is smaller than that of the first braking gear. Therefore, the braking torque applied to the rotating body is amplified when transmitted to the first braking gear. Thus, the vehicle door apparatus facilitates holding the door at the fully open position even when the braking torque applied to the rotating body is small.

In the vehicle door apparatus, the rotating body may include an engaging protrusion protruding in a direction intersecting a rotation direction of the rotating body. The engaging protrusion engages with the braking member in the engaged state, while not engaging with the braking member in the retracted state.

The rotating body may transition to the engaged state when the door moves from a near-fully-open position near the fully open position to the fully open position. The braking member may be a rod-shaped braking lever rotating about a proximal end. The door braking unit may include a biasing member configured to bias the braking member toward the rotating body. The engaging protrusion slides on the braking lever when the door moves from the near-fully-open position to the fully open position. A distance from a rotation axis of the braking lever to a contact point between the engaging protrusion and the braking lever may gradually decrease as the door approaches the fully open position.

When a distance from the rotation axis of the braking lever to the contact point between the engaging protrusion of the rotating body and the braking lever is short, force with which the braking lever pushes the engaging protrusion becomes greater than that when the distance is long. As a result, since friction force between the braking lever and the engaging protrusion increases, the braking torque applied to the rotating body increases. The vehicle door apparatus can increase the braking torque applied to the rotating body by decreasing the distance when the door moves from the near-fully-open position to the fully open position.

In the vehicle door apparatus, a pressure angle between the braking lever and the engaging protrusion may gradually increase as the door approaches the fully open position.

The vehicle door apparatus can increase the braking torque applied to the rotating body by increasing the pressure angle when the door moves from the near-fully-open position to the fully open position.

In the vehicle door apparatus, the braking member may displace between an engaged position of restricting rotation of the rotating body by engaging with the rotating body and a retracted position of allowing rotation of the rotating body by retracting from the rotating body, and the door braking unit may include a biasing member configured to bias the braking member from the retracted position toward the engaged position, and a release member configured to displace the braking member from the engaged position toward the retracted position.

The vehicle door apparatus can restrict rotation of the rotating body in the engaged state by displacing the braking member to the engaged position. That is, the vehicle door apparatus can firmly hold the door disposed at the fully open position. Meanwhile, the vehicle door apparatus can allow rotation of the rotating body in the engaged state by displacing the braking member to the retracted position. That is, the vehicle door apparatus can move the door held at the fully open position toward the fully open position.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A vehicle door apparatus to be applied to a vehicle including a vehicle body having a door opening and a door configured to open and close the door opening, the vehicle door apparatus comprising:
a first link arm including a proximal end rotatably connected to the vehicle body and a distal end rotatably connected to the door;
a second link arm including a proximal end rotatably connected to the vehicle body and a distal end rotatably connected to the door; and
a door braking unit to be disposed on one of the vehicle body and the door, and configured to brake the door by applying braking torque to an end of the first link arm, wherein
the first link arm and the second link arm constitute a four-bar linkage mechanism together with the vehicle body and the door,
the door braking unit includes a rotating body configured to rotate in response to rotation of the first link arm, and a braking member configured to apply braking torque to the first link arm via the rotating body when engaging with the rotating body, and
the rotating body transitions from one of an engaged state of engaging with the braking member and a retracted state of not engaging with the braking member to another of the engaged state and the retracted state in response to rotation of the rotating body, and transitions to the engaged state at least when the door is disposed at a fully open position where the door fully opens the door opening.

2. The vehicle door apparatus according to claim 1, further comprising a door drive unit disposed on one of the vehicle body and the door together with the door braking unit, and configured to open and close the door by applying driving torque to an end of the first link arm, the door drive unit including an electric motor and a plurality of transmission elements configured to amplify output torque from the electric motor and transmit the amplified output torque to the first link arm, wherein
the door braking unit includes a first braking gear configured to rotate together with any one of a plurality of the transmission elements, and a second braking gear configured to rotate together with the rotating body and mesh with the first braking gear.

3. The vehicle door apparatus according to claim 2, wherein
a position where the door fully closes the door opening is a fully closed position,
a rotation amount of the rotating body when the door moves from one of the fully closed position and the fully open position to another of the fully closed position and the fully open position is less than 360 degrees, and
the first braking gear is an intermittent gear configured to intermittently transmit torque to the second braking gear.

4. The vehicle door apparatus according to claim 3, wherein a pitch circle diameter of the second braking gear is smaller than that of the first braking gear.
